(19) United States
(12) Patent Application Publication
(10) Pub. No.: US 2013/0311405 A1
(43) Pub. Date: Nov. 21, 2013

(54) System and Method for Situational Enablement of Context Aware Human Machine Interfaces

(71) Applicant: Wellpoint, Inc., Chicago, IL (US)

(72) Inventors: Atul Apte, North Las Vegas, NV (US); Rickey Tang, Southwick, MA (US)

(21) Appl. No.: 13/894,604

(22) Filed: May 15, 2013

Related U.S. Application Data
(60) Provisional application No. 61/775,887, filed on Mar. 11, 2013.
(60) Provisional application No. 61/647,666, filed on May 16, 2012.

(51) Int. Cl. G06N 5/02

(52) U.S. Cl. CPC G06N 5/02
USPC 706/11

(57) ABSTRACT

Data describing human-machine interfaces available to a user, facts relating to a circumstance of the user, a current human-machine interface being employed by the user, and an initial sentiment associated with the circumstance of the user is received. A target sentiment is computed based on the facts relating to a circumstance of the user. A navigation path to achieve the target sentiment based on the initial sentiment is determined. The next-best human-machine interface to be employed by the user is determined based on the navigation path, the one or more human-machine interfaces available to the user, and the current human-machine interface being employed by the user.

### CROSS REFERENCE TO RELATED APPLICATIONS

This application claims priority to U.S. Provisional Patent Application Nos. 61/647,666, filed May 16, 2012, and 61/775,887, filed Mar. 11, 2013, the entireties of which are incorporated herein by reference.

### TECHNICAL FIELD

This invention relates to selection of human-machine interfaces.

### SUMMARY

The embodiments of the invention are directed to computer implemented methods, systems and computer readable media for determining the next-best human-machine interface. Data describing human-machine interfaces available to a user, facts relating to a circumstance of the user, a current human-machine interface being employed by the user, and an initial sentiment associated with the circumstance of the user is received. A target sentiment is computed based on the facts relating to a circumstance of the user. A navigation path to achieve the target sentiment based on the initial sentiment is determined. The next-best human-machine interface to be employed by the user is determined based on the navigation path, the one or more human-machine interfaces available to the user, and the current human-machine interface being employed by the user.

### BRIEF DESCRIPTION OF THE DRAWINGS

The foregoing summary, as well as the following detailed description of various embodiments, will be better understood when read in conjunction with the appended drawings. It should be understood, however, that the invention is not limited to the precise arrangements and instrumentalities shown.

In the drawings:

FIG. 1 is a flow chart illustrating a methodology in accordance with one embodiment of the present invention;

FIG. 2 is a flow chart illustrating an embodiment of the deterministic logic employed in connection with one embodiment of the present invention;

FIG. 3 is a flow chart illustrating an embodiment of how situational representation is used in connection with one embodiment of the present invention;

FIG. 4 is a representation of the relationship between user preferences, the type or domain of interactions, and the attributes of user experience attributes;

FIG. 5 illustrates an exemplary system of one embodiment of the present invention; and

FIG. 6 illustrates an exemplary system of the present invention.

### DETAILED DESCRIPTION

Described herein is a system and method for dynamic determination of the next best (e.g., appropriate and navigable) human-machine interface (“HMI”) based on recurring analysis of the current situation. A situation is a set of circumstances described by facts, evidence, and/or conditions associated with events or actions in the context of interactions between humans, on the one hand, and humans and machines, on the other hand.

Human-machine interfaces are found in computer applications, mobile devices, monitoring devices, multi-media and consumer electronics, command and control consoles, heavy machinery, by way of example. The diversity and number of HMIs used to complete any specific task is increasing rapidly, especially in knowledge, information, and communication intensive processes.

The dynamic determination of the next best (e.g., appropriate and navigable) HMI leads to significantly better user experience where users spend less time to search for or depend on historic knowledge to determine the next navigable HMI. Instead, computer programs determine the next appropriate and navigable HMI by using available information about the current situation. Presentation of dynamically determined HMIs results in faster resolutions and outcomes.

Ever since the concept of user interfaces (e.g., screens) was first implemented in personal computers, the design of user interfaces has played a big part in making technology accessible. The primary focus of user interface design has been on the structure (form factor) and esthetics. Navigation between user interfaces (e.g., screens within an application or screens across applications) has been pre-determined with very limited choices. These pre-determined user interface navigations are based on historical knowledge and current requirements and, in some instances, limited knowledge of potential real-world situations. As a result, the user interfaces are generally limited in their ability to rapidly change and support evolving real-world situations. This is especially true in circumstances or scenarios with a larger number of variations. An example of this is when, in connection with a physician diagnosing a patient's ailment, the physician considers a whole set of situation parameters other than the patient's obvious symptoms. Designing HMIs to support this type of situation-sensitive information access requires a different approach for interface navigations.

The diversity of machines (computers, mobile devices, heavy-machinery, appliances, command and control console) used by humans is increasing exponentially. By 2015, U.S. citizens on average are likely to possess up to 7 different devices. Navigating between the different devices is a manual task. There is eminent risk of degrading user experience due to tedious navigation between HMIs. However, use of technology to identify the next appropriate, navigable interface to users can help ensure that users are aware of the device and HMI that will be most effective in achieving the right outcome. Improving user experiences is focused on simplifying not just the design of HMIs but also the navigation between available interfaces.

Disclosed is a system and method for determining navigation between HMIs. The navigation could be between two user interface screens of a computer application, or any combination of two interfaces across computer applications, command and control consoles, mobile device screens, interfaces to electronic devices, and heavy machinery.

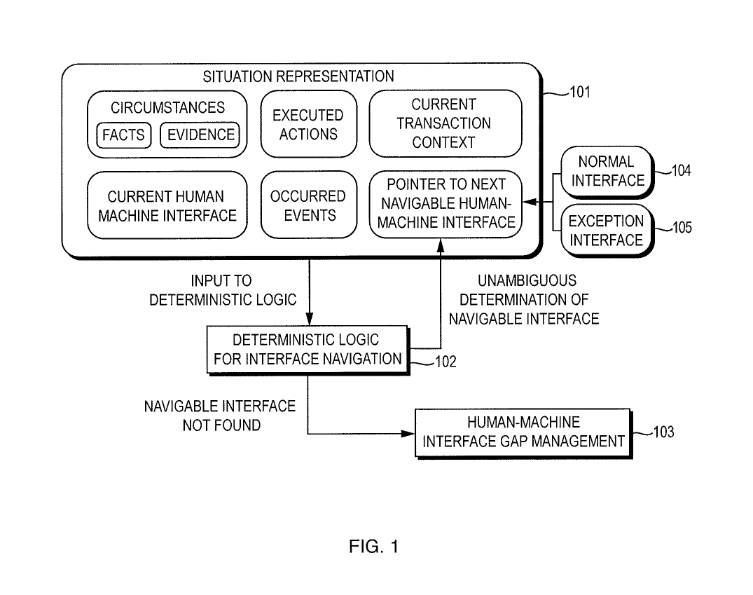

FIG. 1 illustrates the three components involved with determining navigation between HMIs, in an exemplary embodiment: Situation representation 101; Deterministic logic for interface navigation 102; and Gap management 103.

The situation representation component 101 is an information container to hold data and information that describe the particulars of the current situation. For example, data reflecting evidence (such as current medical policies and guidelines), facts (such as submitted claims by the user), and executed actions (such as denial of user/member's claims) would be held in the situation representation container. The data reflecting the situation representation may be maintained in a database or other memory. Some of the information in the container is computed when needed (e.g., like the sentiment index described below); other information is either loaded into the container or is accessed through system interfaces. There may be a great degree of variability in how the container obtains the information necessary for supporting the deterministic logic within the scope of the present invention. Further, the type of deterministic logic that is used to select the next best HMI predominantly determines what information is needed in the container. For example, if the deterministic logic is addressing the next best HMI for a single type of HMI (Web applications) then the type of information needed in the container is simpler (e.g., a list of web applications that the user is registered for (e.g., member portal, web email etc.)). If, on the other hand, the deterministic logic is addressing next best HMI for multiple types of HMIs (e.g., Web applications, smart phone applications, touch-tone IVR applications), then the information needed in the container is more complex (e.g., list of web applications, smart phone numbers, 1-800-IVR numbers, etc.). For each HMI type, the deterministic logic may also include capabilities—e.g., the web application supports all types of customer service interactions, but the 1-800-IVR numbers may only support some types of customer service interactions. Hence, depending on the sentiment index and the type of issue and the type of HMI accessible to the customer, the next best HMI could be transfer to a 1-800 IVR number or to transfer to a web application, such as a member portal.

The definition of a situation is broader and richer compared to the often-used concept of “context” in some of the current user interfaces. Context usually contains information about the current transaction and does not include information of the specific circumstances, such as the current individual sentiments of humans involved in the transaction and related interactions.

The current sentiment of humans involved in a transaction is represented by a sentiment index. The sentiment index is computed based on available historical data and current context. For example, a topic (for which a sentiment index is to be calculated) may have multiple issues associated with it and the possible resolutions of those issues may each be assigned a sentiment index variable. Depending on the human's choice of resolutions for each of the issues, a sentiment index can be determined. With reference to a specific example, Topic A (e.g., customer satisfaction with a telephone call with a Customer Service Representative) is associated with three possible issues (e.g., time on hold, total time of call, courtesy of CSR). Based on the relative importance of the three issues, resolution of the first issue is associated with a weight of 30%; resolution of the second issue is associated with a weight of 20%; and resolution of the third issue is associated with a weight of 50%. There are three potential resolutions for each of the three issues: resolution 1 is assigned a variable=1 (generally satisfied); resolution 2 is assigned a variable of 2 (neutral); and resolution 3 is assigned a variable of 3 (generally unsatisfied). Assume in this example that variable 1 is associated with the resolution of each of the issues for the telephone call with the CSR. Multiplying that variable 1 times each of the weights results in a sentiment index of 1, which can inform the system of the human's sentiment regarding Topic A (e.g., the customer was generally satisfied).

The current HMI is a pointer to user interfaces such as a GUI screen that is currently being displayed or rendered to the user. The next navigable HMI is a pointer to a user interface that will next be displayed to the user. This pointer depends on the data contained in situation representation container and, thus, may change frequently.

The deterministic logic component 102 may be software that uses the situation representation container to determine the most appropriate and navigable HMI to achieve a pre-determined outcome. The type of outcome is computed based on the information in the situation representation container 101. The deterministic logic 102 examines and considers all data in the situation representation container 101, including the sentiment index.

In scenarios where the logical computation of outcome is unsupportable by an appropriately determined HMI, the gap management component 103 determines the most appropriate manual interface, where a human can either trouble shoot the HMI issue or assist with manual resolution, to achieve the same or similar outcome.

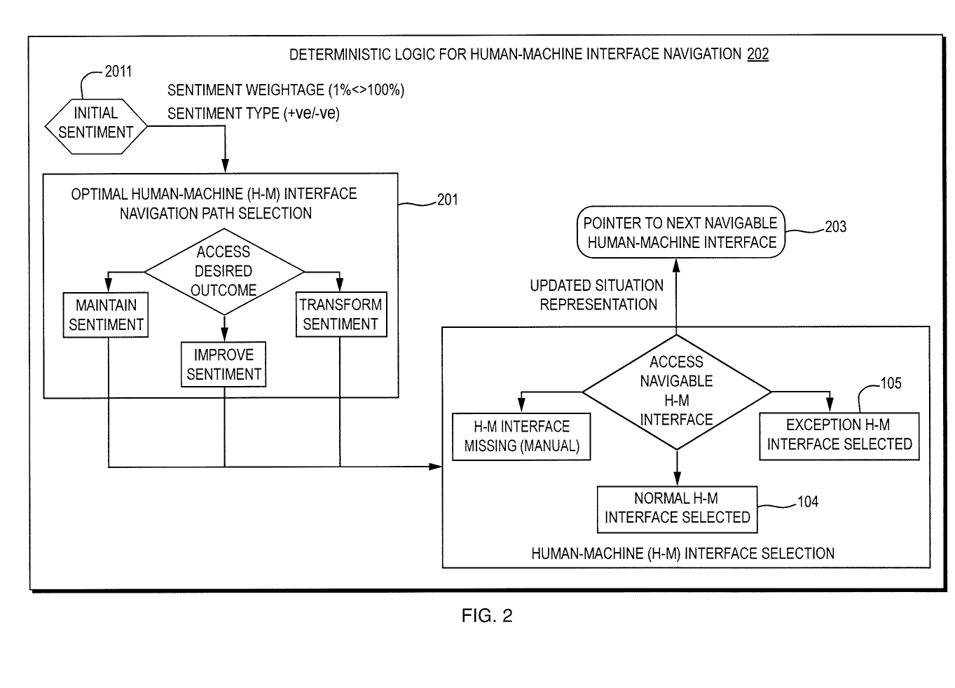

FIG. 2 illustrates the type of deterministic logic 102 used to compute the appropriate outcome path and determine the appropriate navigable HMI. The actual assessment process that results in determination of the outcome path and navigable HMI can be implemented using different, machine specific logic. The deterministic logic can vary depending on the type of HMIs available to the user. For example, if the user has access to only web based applications, there will be one type of deterministic logic (i.e., one that is associated with choosing only web interfaces). If the user has access to geo location enabled mobile device or heads-up-display (HUD) enabled augmented reality, then the deterministic logic will be different from the web based application only deterministic logic because more interfaces are accessible to the human. Thus, the deterministic logic is programmed to know all the available HMIs based on the HMIs that are available to the end user and chooses the next, best navigable HMI based on the information in the container.

There are two steps used in connection with the deterministic logic, in one embodiment. Step 201 determines the optimal navigation path based on the assessed desired outcome. Determination of the optimal navigation path is based on a sentiment index and a set of pre-defined rules. The initial sentiment index 2011 will be in the situation representation container 101. The pre-defined rules determine the target sentiment index which triggers one of three optimal paths (Maintain current sentiment index, Improve current sentiment index, Transform current sentiment index). For example, if the situation representation container has a fact representing the current sentiment of a member, then the assessed desired outcome could be one of several possibilities, for example:

Maintaining the sentiment (assuming current sentiment is very positive) is the navigation path selected

Improving the sentiment (assuming current sentiment is very negative) is the navigation path selected

Transforming the sentiment (assuming current sentiment is not available) is the navigation path selected.

Step 202 uses the selected navigation path to assess the most appropriate and navigable HMI. The selection of appropriate navigable HMI is based on searching (lookup of) interfaces within two categories, normal interfaces 104 and exception interfaces 105 (also shown in FIG. 1). Normal interfaces 104 represent the path of navigation where the desired outcome is achieved every time. Exception interfaces 105 represent the erroneous path of navigation where the desired outcome is not achieved. The traversal of an erroneous navigation path arises in a number of different scenarios. For example, deterministic logic may select the erroneous navigation path when a user may not be able to access the desired interface due to reasons such as location of the user or display type (mobile device or heads-up-display). The assessed interface points to the next navigable HMI 203.

Determining the navigation between two HMIs is a complex process that has traditionally been simplified by limiting choices. Hard-wiring two interfaces or selecting two the next navigable interface from a pre-defined set of choices limits the number and type of real-world situations addressable by human-machine interactions.

Decoupling the interfaces from navigation and not hard-wiring two interfaces creates the possibility of addressing a larger set of human-machine interactions. Leveraging situation information to determine appropriate navigation results in better support for a wider array of interactions and variability.

One embodiment of the invention involves the following aspects.

Navigation between human-computer interfaces is not pre-determined. Navigation to the next, navigable interface element (screen, service, application, device, etc. . . . ) is determined by computing the circumstances responsible for the current situation and the desired outcome.

Interfaces (e.g. U.I. screens or applications) are not pre-wired. Navigation between machines and HMIs supports the user's needs based on an evolving situation. The situation container captures attributes representing the evolving situation. This results in a higher probability of finding the appropriate HMI to achieve the desired outcome specific to the situation.

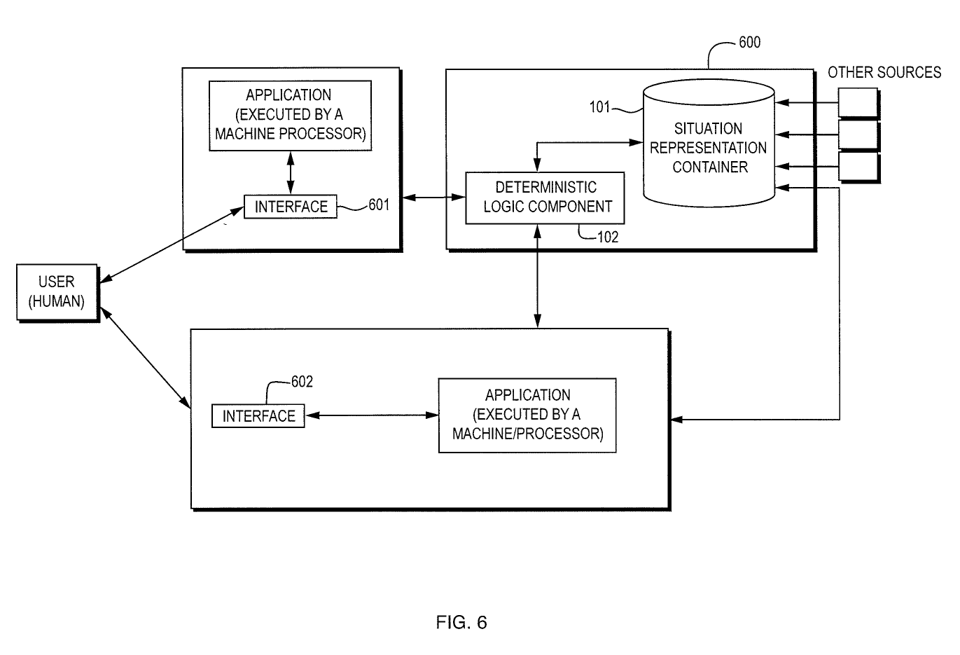

The system (system 600 of FIG. 6) that houses the deterministic logic component and the situation representation container must maintain information about what HMIs are available to the end user. In this regard, the end user may register and attest to his devices with the system 600 specifically to take advantage of the methods described herein. In other instances, the end user may register to take advantage of other services offer (e.g., to purchase products or services, or maintain/monitor accounts etc.). Such registration information may be made available to system 600 to enable it to know what HMIs are available to the end user. Attestation of HMI is part of the registration process and enables the deterministic logic to categorize HMI as normal scenario HMI, an alternate HMI or an exception HMI.

Recursive determination results in a pointer to the next, appropriate, navigable HMI at all times. As the situation evolves, the pointer to HMI is updated with the most appropriate and navigable interface. Recursive use of the entire situation representation container (of which sentiment index is one part) is useful in driving context aware HMIs. Recursive determination is an important aspect because the situation representation container is constantly changing. For example, in one interaction between a user and the system, the system may determine that one interface may serve as the appropriate next step, yet a user may select a different action. The system then tracks and records the user's action in the situation representation container. In a subsequent interaction under similar circumstances, the system will be aware of the previous interaction and suggest the interface previously selected by the user, thus improving the user's overall experience with the system.

In contrast to GPS enabled navigation systems that provide navigation instructions, one navigation point at a time, certain embodiments described herein also have a pointer to the next navigable interface in addition to the current interface. This capability increases the potential for a better user experience as proactive (predictive) recommendations can be supplied to users, thereby minimizing the time to obtain the desired outcome as well as finding the best path to achieve the desired outcome.

Analysis by research teams has shown that there is a co-relation between user preferences, the type of interactions users are involved in and the experiences generated and reported by users.

In the health care industry, interactions between providers and patients, members and payers, providers and payers has higher variability due to unique situations. These unique situations are created by specific circumstances associated with providers, members/patients, and payers.

The system improves the user experience by ensuring appropriate navigation between different types of HMIs including text, video, audio, and tactile interfaces.

The system may also implement appropriate solutions for improving the user (customer) experience across points of sale (public and private exchanges, website, and other sales channels), points of service (customer service, call/contact centers), and points of care (physician office, specialty practices, hospitals, long term care facilities, and other care facilities).

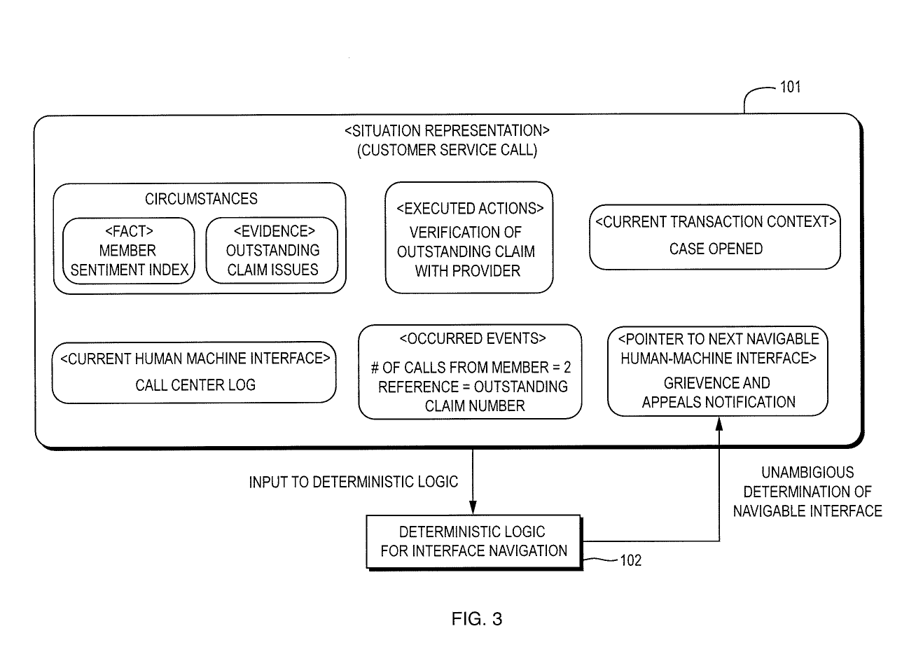

FIG. 3 provides an example of how the systems and methods can be employed. This example involves a call by a consumer to a customer service representative. The situation representation container 101 includes data reflecting a variety of facts and circumstances, including: the customer has an open case; the customer has an issue relating to an outstanding claim; the sentiment index of the consumer is 2, reflecting that the consumer is neutral as to his satisfaction with the manner in which his outstanding claim has been handled to date; the customer's outstanding claim which has been verified with the provider; there have been two calls from the customer regarding his outstanding claim, associated with a claim number; and the current HMI is a call center log (i.e., the customer service representative is interacting with a call center application). This information is inputted to the deterministic logic 102 for interface navigation. The deterministic logic determines that the next navigable HMI is to send a notice to the grievance and appeals web application, commencing that process. The software employing the deterministic logic is programmed to recognize that the current HMI is a call center log and there is only one type of HMI available to the customer service representative (e.g., various web applications that support the call center); that the current sentiment index of 2/neutral should be maintained; and that, of the available HMIs associated with the web application that supports the call center, sending a notice to the grievance and appeals web application is appropriate in view of the fact that the claim has been verified, is outstanding and the consumer continues to have questions about the outstanding claim. Once an action is taken (e.g., the notice is sent to the grievances and appeals web application, or the customer service representative or consumer take some other action), the situation representation container 101 is updated with data reflecting that action. In this manner, the updated situation representation 101 can be used to determine the next best navigable HMI.

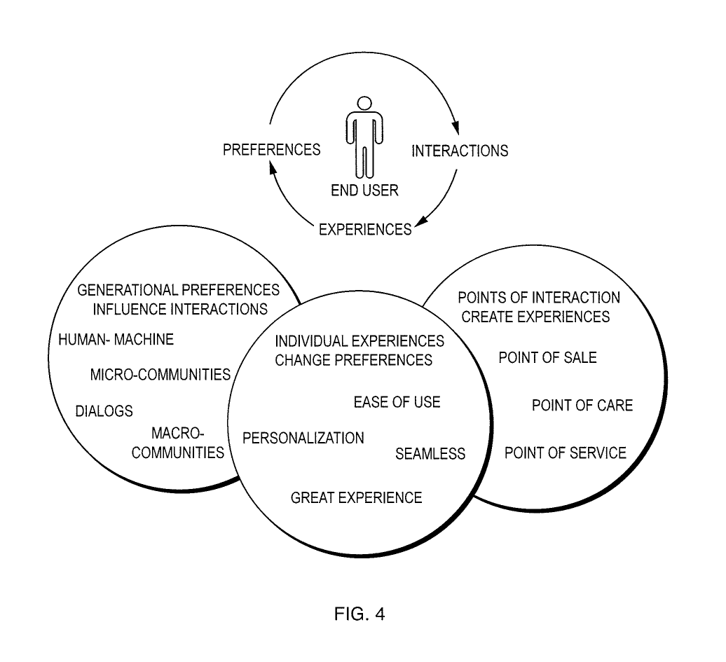

FIG. 4 illustrates the relationship between user preferences such as generational preferences, the type or domain of interactions, and the attributes of a superior user experience (seamless, personalization, ease of use). The disclosed systems and methods solve problems related to seamless user experience and ease of use in generating personalized experiences.

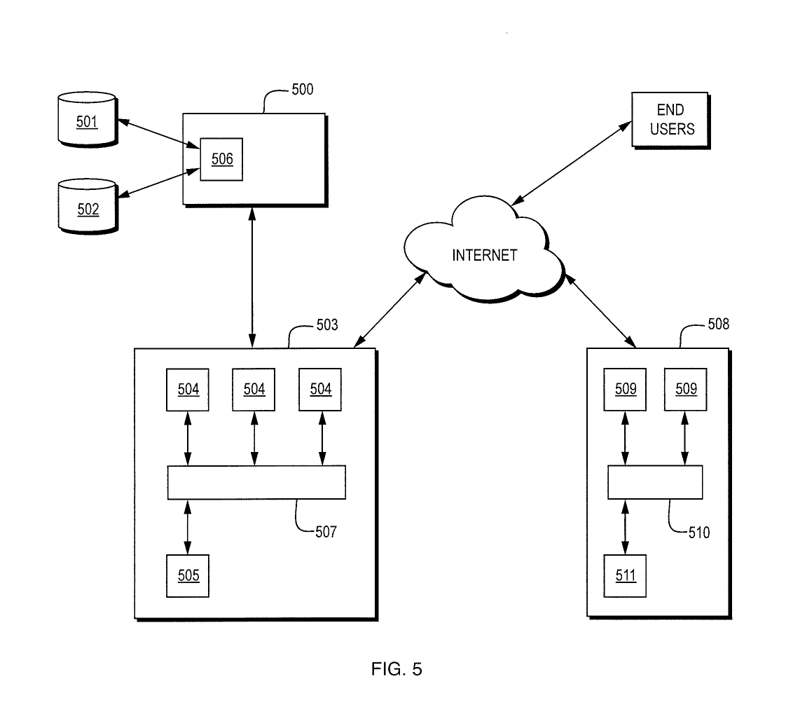

Exemplary hardware and software employed by the systems discussed herein are now generally described with reference to FIG. 5. Database server(s) 500 may include a database services management application 506 that manages storage and retrieval of data from the database(s) 501, 502. The databases may be relational databases; however, other data organizational structures may be used without departing from the scope of the present invention. Databases(s) 501, 502 may store, e.g., the data describing the situation representation. One or more application server(s) 503 are in communication with the database server 500. The application server 503 communicates requests for data to the database server 500. The database server 500 retrieves the requested data. The application server 503 may also send data to the database server for storage in the database(s) 501, 502. The application server 503 comprises one or more processors 504, computer readable storage media 505 that store programs (computer readable instructions) for execution by the processor(s), and an interface 507 between the processor(s) 504 and computer readable storage media 505. The application server 503 may store the computer programs referred to herein. For example, the application server 503 may store the computer program(s) associated with the deterministic logic. An application server (application server 503 or another application server) may also store the computer program(s) associated with the current user interactions (including, e.g., the interfaces associated with the employed computer application to be navigated by the end user). For example, application server 503 may store a claims processing application or a customer service/call center application. Data generated by the end user's interaction with such applications may be stored in database(s) 501, 502 and become part of the situation container.

To the extent data and information is communicated over the Internet, one or more Internet servers 508 may be employed. The Internet server 508 also comprises one or more processors 509, computer readable storage media 511 that store programs (computer readable instructions) for execution by the processor(s) 509, and an interface 510 between the processor(s) 509 and computer readable storage media 511. The Internet server 508 is employed to deliver content that can be accessed through the communications network, e.g., by an end user. When data is requested through an application, such as an Internet browser, the Internet server 508 receives and processes the request. The Internet server 508 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

FIG. 6 also illustrates the flow of data among the components. As referenced above, what is included in the situation representation container 101 is driven in large part by the particular deterministic logic 102 for selecting next best HMI 601, 602. The logic itself is customized for the type of HMI available to the end user (for example a smartphone and a GPS system could be two HMIs accessible to a person who is driving in a car). The next best HMI could be a smartphone interface if the traffic monitoring system detects a restaurant that the person likes and the time of day is afternoon lunch time. The system could send an alert to the smart phone making it easier to place a call and make reservation. If, however, a smart phone is not accessible (e.g., maybe the signal is not strong), then an alert is sent to GPS system, which may not be able to place a call and make reservation, but at least the person is alerted.

The interfaces 601, 602 described herein may be visual interfaces, but need not necessarily have a visual component (e.g., the interface could interact with the end user in some other way such as in an audible or tactile manner).

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A computer implemented method comprising:
receiving data describing one or more human-machine interfaces available to a user, facts relating to a circumstance of the user, a current human-machine interface being employed by the user, and an initial sentiment associated with the circumstance of the user;
computing a target sentiment based on the facts relating to a circumstance of the user;
determining a navigation path to achieve the target sentiment based on the initial sentiment; and
determining a next-best human-machine interface to be employed by the user based on the navigation path, the one or more human-machine interfaces available to the user, and the current human-machine interface being employed by the user.

2. A system comprising:
memory operable to store at least one program; and
at least one processor communicatively coupled to the memory, in which the at least one program, when executed by the at least one processor, causes the at least one processor to:
receive data describing one or more human-machine interfaces available to a user, facts relating to a circumstance of the user, a current human-machine interface being employed by the user, and an initial sentiment associated with the circumstance of the user;
compute a target sentiment based on the facts relating to a circumstance of the user;
determine a navigation path to achieve the target sentiment based on the initial sentiment; and
determine a next-best human-machine interface to be employed by the user based on the navigation path, the one or more human-machine interfaces available to the user, and the current human-machine interface being employed by the user.

3. A non-transitory computer-readable storage medium that stores instructions which, when executed by one or more processors, cause the one or more processors to perform a method comprising:
receiving data describing one or more human-machine interfaces available to a user, facts relating to a circumstance of the user, a current human-machine interface being employed by the user, and an initial sentiment associated with the circumstance of the user;
computing a target sentiment based on the facts relating to a circumstance of the user;
determining a navigation path to achieve the target sentiment based on the initial sentiment; and
determining a next-best human-machine interface to be employed by the user based on the navigation path, the one or more human-machine interfaces available to the user, and the current human-machine interface being employed by the user.
